(19) United States
(12) Patent Application Publication
(10) Pub. No.: US 2025/0329025 A1
(43) Pub. Date: Oct. 23, 2025

(54) OBJECT DETECTING APPARATUS AND OBJECT DETECTION METHOD

(71) Applicant: Mitsubishi Electric Corporation, Tokyo (JP)

(72) Inventors: Teng-Yok LEE, Tokyo (JP); Shotaro ISHIGAMI, Tokyo (JP); Akira MINEZAWA, Tokyo (JP)

(73) Assignee: Mitsubishi Electric Corporation, Tokyo (JP)

(21) Appl. No.: 19/256,928

(22) Filed: Jul. 1, 2025

Related U.S. Application Data
(63) Continuation of application No. PCT/JP2023/008943, filed on Mar. 9, 2023.

(51) Int. Cl. G06T 7/11; G06V 10/25; G06V 10/82; G06V 40/10

(52) U.S. Cl. CPC G06T 7/11; G06V 10/25; G06V 10/82; G06V 40/103; G06T 2207/20084; G06T 2207/30196

(57) ABSTRACT

An object detecting apparatus includes processing circuitry configured to; detect an object in an input image and generate one or more bounding boxes enclosing the object; select, if a plurality of mutually overlapping bounding boxes is generated, one bounding box from the plurality of mutually overlapping bounding boxes on a basis of a reliability of each of bounding boxes; calculate an overlap between each of bounding boxes having been generated and the bounding box having been selected; and calculate a contribution of a pixel contributing to the detection of the object in a plurality of pixels included in the input image on a basis of the calculated overlap.

### CROSS REFERENCE TO RELATED APPLICATION

This application is a Continuation of PCT International Application No. PCT/JP2023/008943, filed on Mar. 9, 2023, which is hereby expressly incorporated by reference into the present application.

### TECHNICAL FIELD

The present disclosure relates to an object detecting apparatus and an object detection method.

### BACKGROUND ART

There are object detecting apparatuses to detect objects in an input image by using an object detection model for detecting objects.

As an example of such an object detecting apparatus, Patent Literature 1 discloses an object detecting apparatus including an adding unit and a removing unit.

The adding unit detects objects in an input image, and generates bounding boxes enclosing the objects. The removing unit executes a filtering process called NMS (Non-Maximum Suppression) if a plurality of mutually overlapping bounding boxes are generated by the adding unit, thereby keeping the most reliable bounding box in the plurality of bounding boxes, and removing the other bounding boxes.

### CITATION LIST

### Patent Literature

Patent Literature 1: JP 2022-118954 A

### SUMMARY OF INVENTION

### Technical Problem

As an object detection model, for example, a deep-learning-based image recognition model is used in some cases. The deep-learning-based image recognition model is typically created through deep learning. Because of this, it is difficult in some cases for users to clearly understand bases for detection of objects by the image recognition model. Accordingly, it would be useful for users in understanding bases for detection of objects if an object detecting apparatus can visualize pixels contributing to the detection of the objects in a plurality of pixels included in an input image.

If partial derivatives of NMS can be obtained, the gradient of a bounding box kept by NMS is determined about each of a plurality of mutually overlapping bounding boxes. If the gradient of the bounding box having been kept is determined, the contributions of pixels contributing to detection of an object in a plurality of pixels included in an input image may be able to be computed on the basis of the gradient of the bounding box having been kept.

However, it is difficult to obtain partial derivatives of NMS since NMS is not represented by a partial differential equation. Because of this, there has been a problem with the object detecting apparatus disclosed in Patent Literature 1 that the gradient of a bounding box kept by NMS cannot be calculated for each of a plurality of mutually overlapping bounding boxes.

The present disclosure has been made to solve problems like the one described above, and an object thereof is to obtain an object detecting apparatus that can present the contributions of pixels contributing to detection of an object in a plurality of pixels included in an input image.

### Solution to Problem

An object detecting apparatus according to the present disclosure includes: processing circuitry configured to; detect an object in an input image and generate one or more bounding boxes enclosing the object; select, if a plurality of mutually overlapping bounding boxes is generated, one bounding box from the plurality of mutually overlapping bounding boxes on a basis of a reliability of each of bounding boxes; calculate an overlap between each of bounding boxes having been generated and the bounding box having been selected; and calculate a contribution of a pixel contributing to the detection of the object in a plurality of pixels included in the input image on a basis of the calculated overlap.

### Advantageous Effects of Invention

According to the present disclosure, the contributions of pixels contributing to detection of an object in a plurality of pixels included in an input image can be presented.

### BRIEF DESCRIPTION OF DRAWINGS

FIG. 1 is a configuration diagram depicting an object detecting apparatus 1 according to a first embodiment.

FIG. 2 is a hardware configuration diagram depicting hardware of the object detecting apparatus 1 according to the first embodiment.

FIG. 3 is a hardware configuration diagram of a computer in a case where the object detecting apparatus 1 is implemented by using software, firmware or the like.

FIG. 4 is a flowchart depicting an object detection method which is a process procedure performed in the object detecting apparatus 1.

FIG. 5 is an explanatory diagram depicting an example of an input image.

FIG. 6 is an explanatory diagram depicting an example of generation of bounding boxes by a box generating unit 11.

FIG. 7 is an explanatory diagram depicting a process of computing an overlap DS_{i,j} between a bounding box X_{i,j} and a bounding box Xᵢ′.

FIG. 8 is an explanatory diagram depicting an example of a Grad-CAM image.

FIG. 9 is a configuration diagram depicting an object detecting apparatus 1 according to a second embodiment.

FIG. 10 is a hardware configuration diagram depicting hardware of the object detecting apparatus 1 according to the second embodiment.

FIG. 11 is a configuration diagram depicting an object detecting apparatus 1 according to a third embodiment.

### DESCRIPTION OF EMBODIMENTS

Hereinafter, embodiments of the present disclosure are explained with reference to the attached figures in order to explain the present disclosure in more detail.

### First Embodiment

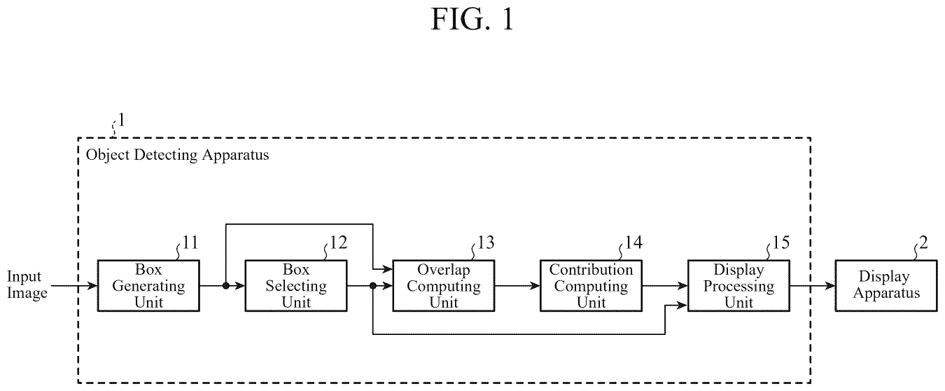

FIG. 1 is a configuration diagram depicting an object detecting apparatus 1 according to a first embodiment.

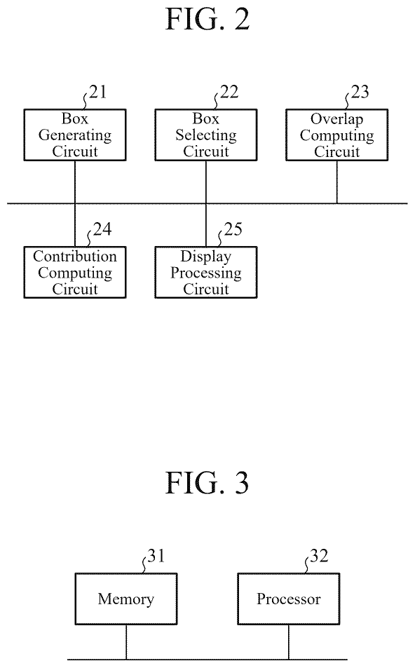

FIG. 2 is a hardware configuration diagram depicting hardware of the object detecting apparatus 1 according to the first embodiment.

The object detecting apparatus 1 depicted in FIG. 1 detects objects in an input image, and generates one or more bounding boxes enclosing the objects.

In addition, the object detecting apparatus 1 computes the contributions of pixels contributing to the detection of the objects in a plurality of pixels included in the input image.

A display apparatus 2 displays, on its display, an image representing the contributions of the pixels computed by the object detecting apparatus 1.

The object detecting apparatus 1 depicted in FIG. 1 includes a box generating unit 11, a box selecting unit 12, an overlap computing unit 13, a contribution computing unit 14 and a display processing unit 15.

The box generating unit 11 is implemented by a box generating circuit 21 depicted in FIG. 2, for example.

The box generating unit 11 uses a deep-learning-based image recognition model as an object detection model, for example. The object detection model is an object detection algorithm.

It is assumed that, in the object detecting apparatus 1 depicted in FIG. 1, the box generating unit 11 uses a convolutional neural network (hereinafter, called an “OD-CNN (Object Detection-Convolutional Neural Network)”) as an image recognition model. The OD-CNN may be stored on an internal memory of the box generating unit 11 or may be stored on an external memory of the box generating unit 11.

The box generating unit 11 acquires image data of an input image from the outside.

The box generating unit 11 detects objects in the input image, and generates one or more bounding boxes enclosing the objects.

Specifically, the box generating unit 11 provides the image data of the input image to the OD-CNN, and acquires the one or more bounding boxes enclosing the objects from the OD-CNN. When provided with the image data of the input image, the OD-CNN generates the one or more bounding boxes enclosing the objects in the input image by using each of one or more filters.

The OD-CNN generates feature maps (Feature maps) when performing the object detection process. The feature maps are three-dimensional boxes having dimensions of a widthwise direction w of the input image, a height direction h of the input image and a filter count c of object detection filters. c=1, . . . , C. C is an integer which is equal to or greater than one.

For example, if the types of objects detected by the box generating unit 11 are human, dog and cat, the OD-CNN performs the object detection process by using human detection filters, dog detection filters and cat detection filters. If the number of each of these types of detection filter is one, C=3. It should be noted that the number of each of these types of detection filter is not limited to one, and the OD-CNN may use a plurality of filters as dog detection filters, for example. If there is one human detection filter, three dog detection filters and one cat detection filter, C=1+3+1=5.

The OD-CNN generates one or more bounding boxes enclosing objects in the input image on the basis of the feature maps. If a plurality of objects are captured in the input image, the OD-CNN generates one or more bounding boxes of each object.

The box generating unit 11 outputs the one or more bounding boxes of each object to each of the box selecting unit 12 and the overlap computing unit 13.

The box selecting unit 12 is implemented by a box selecting circuit 22 depicted in FIG. 2, for example.

If the box generating unit 11 generates a plurality of mutually overlapping bounding boxes of each object, the box selecting unit 12 executes a filtering process called NMS.

By executing the filtering process, the box selecting unit 12 keeps the most reliable bounding box in the plurality of bounding boxes, and removes the other bounding boxes.

Specifically, the box selecting unit 12 computes the reliability of each of bounding boxes, and compares the reliabilities of the plurality of bounding boxes with each other. On the basis of results of the comparison of the reliabilities, the box selecting unit 12 selects the most reliable bounding box from the plurality of bounding boxes.

The box selecting unit 12 outputs a selected bounding box of each object to each of the overlap computing unit 13 and the display processing unit 15.

In the object detecting apparatus 1 depicted in FIG. 1, the box selecting unit 12 selects the most reliable bounding box from the plurality of bounding boxes. However, this is merely an example, and the box selecting unit 12 may select the second most reliable bounding box, for example, if there are no practical problems.

In addition, in the object detecting apparatus 1 depicted in FIG. 1, the box selecting unit 12 selects the one most reliable bounding box from the plurality of bounding boxes. However, this is merely an example, and the box selecting unit 12 may select the top G most reliable bounding boxes from the plurality of bounding boxes. G is an integer which is equal to or greater than two.

The overlap computing unit 13 is implemented by an overlap computation circuit 23 depicted in FIG. 2, for example.

The overlap computing unit 13 acquires one or more bounding boxes of each object from the box generating unit 11.

The overlap computing unit 13 acquires a selected bounding box of each object from the box selecting unit 12.

The overlap computing unit 13 computes the overlap between each of bounding boxes and a selected bounding box of each object.

Specifically, the overlap computing unit 13 computes a first overlap which is the overlap between each of the bounding boxes that are generated by the OD-CNN and correspond to all of object detection filters, and a bounding box selected by the box selecting unit 12. Then, the overlap computing unit 13 computes a second overlap which is the total of the first overlaps corresponding to all of the object detection filters.

For example, when the type of an object is human, and there are three human detection filters, the overlap computing unit 13 computes three first overlaps, and computes the total of the three first overlaps as a second overlap.

For example, when the type of an object is dog, and there are five dog detection filters, the overlap computing unit 13 computes five first overlaps, and computes the total of the five first overlaps as a second overlap.

For example, when the type of an object is cat, and there are four cat detection filters, the overlap computing unit 13 computes four first overlaps, and computes the total of the four first overlaps as a second overlap.

The overlap computing unit 13 outputs a second overlap as the overlap computed about each object to the contribution computing unit 14.

The contribution computing unit 14 is implemented by a contribution computation circuit 24 depicted in FIG. 2, for example.

The contribution computing unit 14 acquires a second overlap of each object from the overlap computing unit 13.

The contribution computing unit 14 computes the contributions of pixels contributing to detection of each object in a plurality of pixels included in an input image on the basis of the second overlap of each object.

The contribution computing unit 14 outputs, to the display processing unit 15, an image representing the contributions of pixels contributing to detection of each object.

The display processing unit 15 is implemented by a display processing circuit 25 depicted in FIG. 2, for example.

The display processing unit 15 acquires a selected bounding box of each object from the box selecting unit 12.

In addition, the display processing unit 15 acquires, from the contribution computing unit 14, an image representing the contributions of pixels contributing to detection of each object.

The display processing unit 15 causes bounding boxes selected by the box selecting unit 12 to be displayed on the display of the display apparatus 2.

In addition, the display processing unit 15 causes an image representing the contributions of pixels contributing to detection of each object to be displayed on the display of the display apparatus 2.

It is assumed in FIG. 1 that each of the box generating unit 11, the box selecting unit 12, the overlap computing unit 13, the contribution computing unit 14 and the display processing unit 15 which are constituent elements of the object detecting apparatus 1 is implemented by dedicated hardware like the one depicted in FIG. 2. That is, it is assumed that the object detecting apparatus 1 is implemented by the box generating circuit 21, the box selecting circuit 22, the overlap computation circuit 23, the contribution computation circuit 24 and the display processing circuit 25.

Each of the box generating circuit 21, the box selecting circuit 22, the overlap computation circuit 23, the contribution computation circuit 24 and the display processing circuit 25 is a single circuit, a composite circuit, a programmed processor, a parallel-programmed processor, an ASIC (Application Specific Integrated Circuit) or an FPGA (Field-Programmable Gate Array) or a combination of these, for example.

The constituent elements of the object detecting apparatus 1 may not be implemented by dedicated hardware, but the object detecting apparatus 1 may be implemented by software, firmware or a combination of software and firmware.

Software or firmware is stored as a program on a memory of a computer. The computer means hardware that executes programs, and is a CPU (Central Processing Unit), a GPU (Graphics Processing Unit), a central processor, a processing apparatus, an arithmetic operation apparatus, a microprocessor, a microcomputer, a processor or a DSP (Digital Signal Processor), for example.

FIG. 3 is a hardware configuration diagram of a computer in a case where the object detecting apparatus 1 is implemented by using software, firmware or the like.

In a case where the object detecting apparatus 1 is implemented by software, firmware or the like, a program for causing the computer to execute each process procedure performed in the box generating unit 11, the box selecting unit 12, the overlap computing unit 13, the contribution computing unit 14 and the display processing unit 15 is stored on a memory 31. Then, a processor 32 of the computer executes the programs stored on the memory 31.

In addition, FIG. 2 depicts an example in which each of the constituent elements of the object detecting apparatus 1 is implemented by dedicated hardware, and FIG. 3 depicts an example in which the object detecting apparatus 1 is implemented by software, firmware or the like. However, this is merely an example, and some constituent elements of the object detecting apparatus 1 may be implemented by dedicated hardware, and the remaining constituent elements may be implemented by software, firmware or the like.

Next, operation of the object detecting apparatus 1 depicted in FIG. 1 is explained.

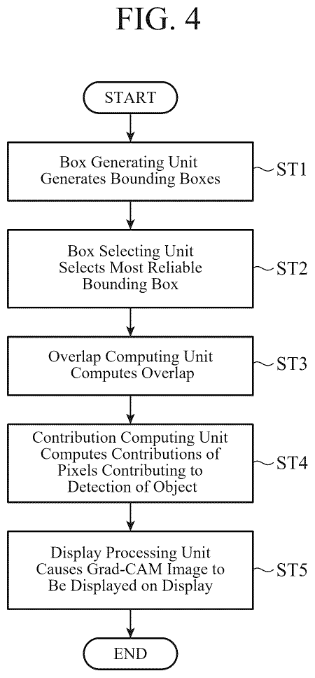

FIG. 4 is a flowchart depicting an object detection method which is a process procedure performed in the object detecting apparatus 1.

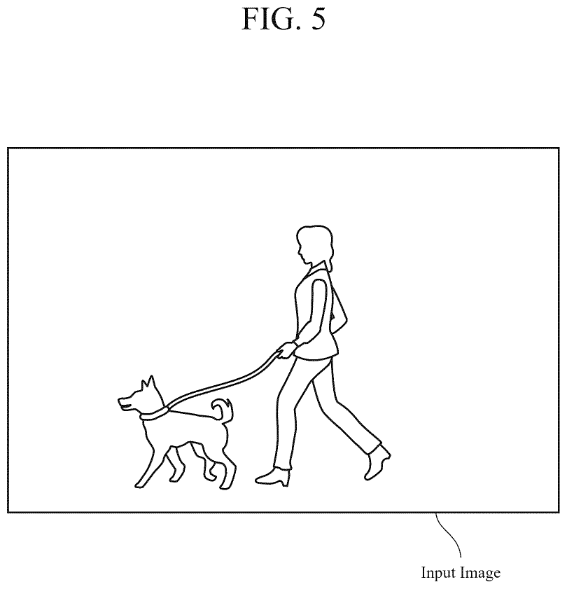

The box generating unit 11 acquires, from the outside, image data of an input image like the one depicted in FIG. 5, for example.

FIG. 5 is an explanatory diagram depicting an example of the input image.

In the example in FIG. 5, a human and a dog are captured as objects in the input image.

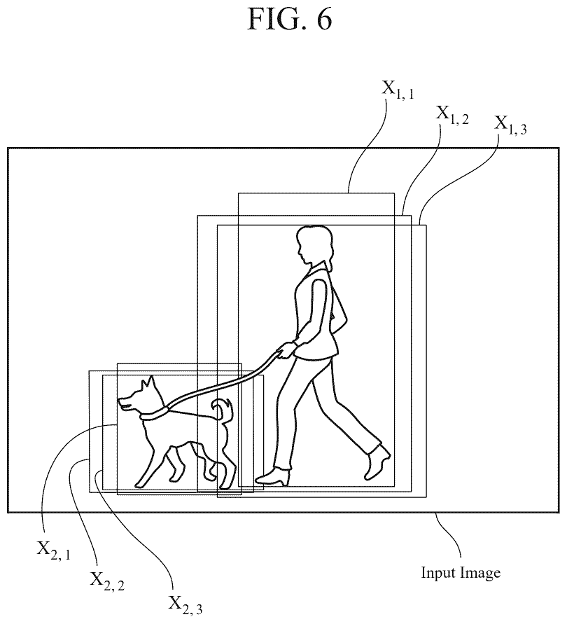

The box generating unit 11 provides the image data of the input image to the OD-CNN. When provided with the image data of the input image from the box generating unit 11, the OD-CNN generates one or more bounding boxes X_{i,j} enclosing the objects in the input image by using each of one or more object detection filters (Step ST1 in FIG. 4). The box generating unit 11 generates one or more bounding boxes X_{i,1}, . . . , X_{i,J} of each object as depicted in FIG. 6 if a plurality of objects are captured in the input image.

FIG. 6 is an explanatory diagram depicting an example of generation of bounding boxes by the box generating unit 11.

i=1, . . . , I, and I is the number of objects in the input image. For example, if there are two objects in the input image, I=2, and if there are three objects in the input image, I=3. In the example in FIG. 5, there are two objects in the input image.

The one or more bounding boxes X_{i,1}, . . . , X_{i,J} of each object overlap mutually. j=1, . . . , J. J is the number of object detection filters of each object, and is the number of bounding boxes generated for each object. For example, when the type of an object is human, and there are three human detection filters, J=3. For example, when the type of an object is dog, and there are five dog detection filters, J=5. For example, when the type of an object is cat, and there are four cat detection filters, J=4.

Processes of generating bounding boxes themselves are a known technology, and accordingly, a detailed explanation thereof is omitted.

In the example in FIG. 6, the numbers of human detection filters and dog detection filters are each three, and three bounding boxes X_{1,1}, X_{1,2} and X_{1,3} enclosing the human and three bounding boxes X_{2,1}, X_{2,2} and X_{2,3} enclosing the dog are generated.

Each bounding box X_{i,j} is a rectangular area.

Each bounding box X_{i,j} has, as its attribute values, class probabilities X_{i,j}[cp, 1] . . . . X_{i,j}[cp,M], and coordinates X_{i,j}[w₁,h₁], X_{i,j}[w₂,h₂], X_{i,j}[w₃,h₃] and X_{i,j}[w₄,h₄] of four vertices of the rectangular areas.

Each class probability X_{i,j}[cp,m] (m=1, . . . , M) is a probability that the type of an object enclosed by the bounding box X_{i,j} is a certain object type. Specifically, the class probability X_{i,j}[cp,1] represents a probability that an object enclosed by the bounding box X_{i,j} is a human, the class probability X_{i,j}[cp,2] represents a probability that the object enclosed by the bounding box X_{i,j} is a dog, the class probability X_{i,j}[cp,3] represents a probability that the object enclosed by the bounding box X_{i,j} is a cat, and so on. M is an integer which is equal to or greater than one.

The X_{i,j}[w₁,h₁] is the coordinates of the upper left vertex in the four vertices of a rectangular area. The X_{i,j}[w₂,h₂] is the coordinates of the upper right vertex in the four vertices of the rectangular area. The X_{i,j}[w₃,h₃] is the coordinates of the lower left vertex in the four vertices of the rectangular area. The X_{i,j}[w₄,h₄] is the coordinates of the lower right vertex in the four vertices of the rectangular area.

The box generating unit 11 outputs one or more bounding boxes X_{i,j} of each object to each of the box selecting unit 12 and the overlap computing unit 13.

The box selecting unit 12 acquires one or more bounding boxes X_{i,j} of each object from the box generating unit 11.

If there is one bounding box X_{i,j} of an object, the box selecting unit 12 outputs the bounding box X_{i,j} to each of the overlap computing unit 13 and the display processing unit 15 as a selected bounding box Xᵢ′.

If there are a plurality of bounding boxes X_{i,j} of an object, the box selecting unit 12 executes a filtering process called NMS on the plurality of bounding boxes X_{i,j} of the object.

By executing the filtering process, the box selecting unit 12 keeps the most reliable bounding box in the plurality of bounding boxes X_{i,j}, and removes the other bounding boxes.

Specifically, the box selecting unit 12 computes a reliability DR_{i,j} of each bounding box X_{i,j} of each object. Processes of computing the reliability DR_{i,j} themselves are a known technology, and accordingly, a detailed explanation thereof is omitted.

For example, if the bounding box X_{i,j} is a bounding box enclosing a human, a class probability that an enclosed object is a human in the class probabilities X_{i,j}[cp, 1] . . . . X_{i,j}[cp,M] of the bounding box X_{i,j} can be used as the reliability DR_{i,j} of the bounding box X_{i,j}.

For example, if the bounding box X_{i,j} is a bounding box enclosing a dog, a class probability that an enclosed object is a dog in the class probabilities X_{i,j}[cp, 1] . . . . X_{i,j}[cp,M] of the bounding box X_{i,j} can be used as the reliability DR_{i,j} of the bounding box X_{i,j}.

The box selecting unit 12 selects the most reliable bounding box Xᵢ′ from a plurality of bounding boxes X_{i,1}, . . . , X_{i,J} on the basis of the reliability DR_{i,j} of each bounding box X_{i,j} (Step ST2 in FIG. 4).

The box selecting unit 12 outputs a selected bounding box Xᵢ′ of each object to each of the overlap computing unit 13 and the display processing unit 15.

The overlap computing unit 13 acquires one or more bounding boxes X_{i,j} of each object from the box generating unit 11.

In addition, the overlap computing unit 13 acquires a selected bounding box Xᵢ′ of each object from the box selecting unit 12.

The overlap computing unit 13 computes an overlap DS_{i,j} between each bounding box X_{i,j} and a selected bounding box Xᵢ′ of each object (Step ST3 in FIG. 4).

The overlap computing unit 13 outputs the overlap DS_{i,j} computed for each object to the contribution computing unit 14.

A process of computing overlaps by the overlap computing unit 13 is explained below specifically.

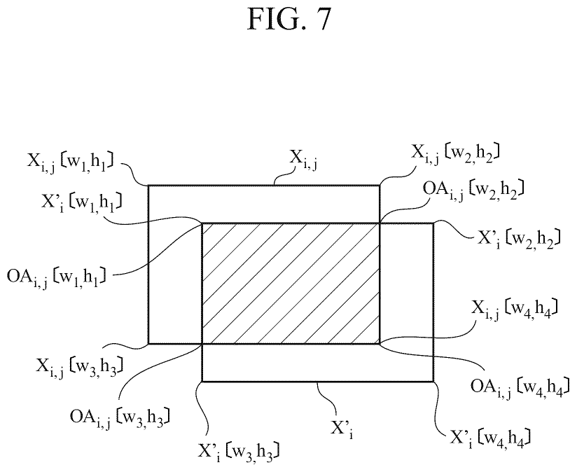

FIG. 7 is an explanatory diagram depicting a process of computing the overlap DS_{i,j} between a bounding box X_{i,j} and a bounding box Xᵢ′.

The overlap computing unit 13 computes an area W_{i,j} of the bounding box X_{i,j} on the basis of the coordinates X_{i,j}[w₁,h₁], X_{i,j}[w₂,h₂], X_{i,j}[w₃,h₃] and X_{i,j}[w₄,h₄] of the four vertices, which are attribute values of the bounding box X_{i,j}.

The overlap computing unit 13 computes the area Wᵢ′ of the bounding box Xᵢ′ on the basis of the coordinates Xᵢ′ [w₁,h₁], Xᵢ′ [w₂,h₂], Xᵢ′ [w₃,h₃] and Xᵢ′ [w₄,h₄] of the four vertices, which are attribute values of the bounding box Xᵢ′.

Next, the overlap computing unit 13 computes coordinates OA_{i,j}[w₁,h₁], OA_{i,j}[w₂,h₂], OA_{i,j}[w₃,h₃] and OA_{i,j}[w₄,h₄] of the four vertices of an overlapping area of the bounding box X_{i,j} and the bounding box Xᵢ′, from the coordinates of the four vertices, which are attribute values of the bounding box X_{i,j}, and the coordinates of the four vertices, which are attribute values of the bounding box Xᵢ′. In the example in FIG. 7, the overlapping area is a shaded area.

The overlap computing unit 13 computes an area (X_{i,j}∩Xᵢ′) of the overlapping area on the basis of the coordinates OA_{i,j}[w₁,h₁], OA_{i,j}[w₂,h₂], OA_{i,j}[w₃,h₃] and OA_{i,j}[w₄,h₄] of the four vertices of the overlapping area.

Next, the overlap computing unit 13 computes the area (X_{i,j}∪Xᵢ′) of the union of the bounding box X_{i,j} and the bounding box Xᵢ′ by subtracting the area (X_{i,j}∩Xᵢ′) of the overlapping area from the sum of the area W_{i,j} of the bounding box X_{i,j} and the area Wᵢ′ of the bounding box Xᵢ′.

The overlap computing unit 13 computes a first overlap DS(1)_{i,j} between the bounding box X_{i,j} and the bounding box Xᵢ′ by dividing the area (X_{i,j}∩Xᵢ′) of the overlapping area by the area (X_{i,j}∪Xᵢ′) of the union, as represented by the following Formula (1).

$${DS ( 1 )}_{i , j} = ( {X}_{i , j} {∩X}_{i}^{′} ) / ( {X}_{i , j} ⋃ {X}_{i}^{′} ) \qquad ( 1 )$$

After computing the first overlaps DS(1)_{i,1}, . . . , DS(1)_{i,J} of J bounding boxes X_{i,1}, . . . , X_{i,J}, the overlap computing unit 13 computes a second overlap DS(2)ᵢ by computing the total of the J first overlaps DS(1)_{i,1}, . . . , DS(1)_{i,J} as depicted in the following Formula (2).

$${DS ( 2 )}_{i} = {DS ( 1 )}_{i , 1} + … + {DS ( 1 )}_{i , J} \qquad ( 2 )$$

The overlap computing unit 13 outputs, to the contribution computing unit 14, the second overlap DS(2)ᵢ of each object as the overlap DS_{i,j} of the object.

The contribution computing unit 14 acquires the overlap DS_{i,j} of each object from the overlap computing unit 13.

The contribution computing unit 14 computes the contributions of pixels contributing to detection of each object in a plurality of pixels included in the input image by calculating partial derivatives of the overlap DS_{i,j} about pixels included in the input image (Step ST4 in FIG. 4).

The contribution computing unit 14 outputs, to the display processing unit 15, an image representing the contributions of pixels contributing to detection of each object.

A process of computing contributions by the contribution computing unit 14 is explained below specifically.

The process of computing the contribution can use a technique called Grad-CAM (Gradient-weighted Class Activation Mapping) depicted below, for example.

The contribution computing unit 14 computes the gradient of a bounding box Xᵢ′ of each of a plurality of convolutional layers of the OD-CNN by using backward propagations of errors of the overlap DS_{i,j} of the bounding box Xᵢ′ by using Grad-CAM in the OD-CNN used by the box generating unit 11. Processes of computing the gradient of a bounding box Xᵢ′ of a convolutional layer are a known technology, and accordingly, a detailed explanation is omitted.

Next, the contribution computing unit 14 determines global average pooling (hereinafter, called “GAP”) of the gradient of each convolutional layer, and weighted-addition of the plurality of convolutional layers is performed by using the GAP of each convolutional layer as a weighting factor.

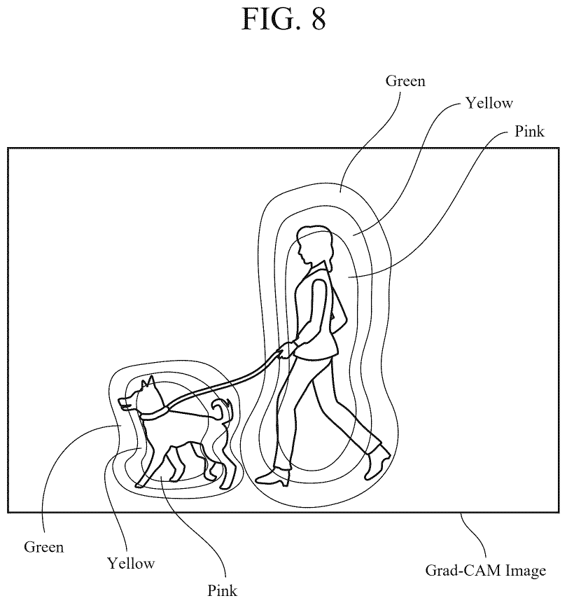

The contribution computing unit 14 generates a Grad-CAM image like the one depicted in FIG. 8 by resizing an image representing a result of the weighted-addition of the plurality of convolutional layers such that the image has the image size of the input image.

FIG. 8 is an explanatory diagram depicting an example of a Grad-CAM image.

The Grad-CAM image is an image representing the contributions of pixels contributing to detection of objects, and the pixels have different colors depending on their contributions.

In the example in FIG. 8, pixels with the highest contributions are displayed in pink, pixels with the second highest contributions are displayed in yellow, and pixels with the third highest contributions are displayed in green. It should be noted that this is merely an example, and contributions may be displayed in colors different from the colors described above.

The display processing unit 15 acquires a selected bounding box of each object from the box selecting unit 12.

The display processing unit 15 causes bounding boxes selected by the box selecting unit 12 to be displayed on the display of the display apparatus 2 (see FIG. 6).

In addition, the display processing unit 15 acquires, from the contribution computing unit 14, a Grad-CAM image representing the contributions of pixels of each object. The display processing unit 15 acquires a Grad-CAM image like the one depicted in FIG. 8, for example.

The display processing unit 15 causes the Grad-CAM image to be displayed on the display of the display apparatus 2 (Step ST5 in FIG. 4).

In the first embodiment mentioned above, the object detecting apparatus 1 is configured such that it includes: the box generating unit 11 to detect an object in an input image, and generate bounding boxes enclosing the object; and the box selecting unit 12 to select one bounding box from a plurality of mutually overlapping bounding boxes on the basis of the reliability of each of bounding boxes if the plurality of bounding boxes are generated by the box generating unit 11. In addition, the object detecting apparatus 1 includes: the overlap computing unit 13 to compute the overlap between each of bounding boxes generated by the box generating unit 11 and the bounding box selected by the box selecting unit 12; and the contribution computing unit 14 to compute the contributions of pixels contributing to detection of the object in a plurality of pixels included in the input image on the basis of the overlap computed by the overlap computing unit 13. Accordingly, the object detecting apparatus 1 can present the contributions of the pixels contributing to the detection of the object in the plurality of pixels included in the input image.

### Second Embodiment

An object detecting apparatus 1 in which an overlap computing unit 17 performs weighted-addition of the first overlap DS(1)_{i,1}, . . . , DS(1)_{i,J} of each of the J bounding boxes X_{i,1}, . . . , X_{i,J} is explained in a second embodiment.

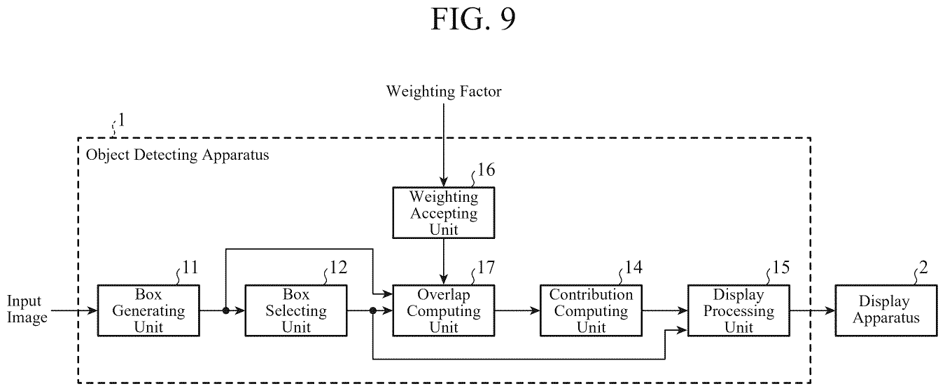

FIG. 9 is a configuration diagram depicting the object detecting apparatus 1 according to the second embodiment. In FIG. 9, the same reference signs as in FIG. 1 represent the same or equivalent portions, and accordingly, detailed explanations thereof are omitted.

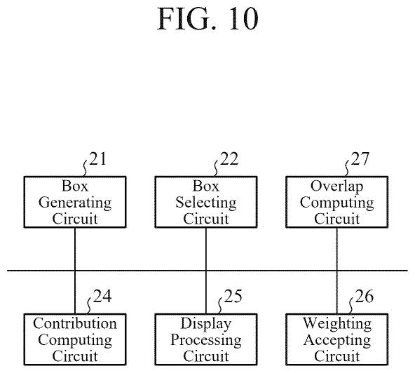

FIG. 10 is a hardware configuration diagram depicting hardware of the object detecting apparatus 1 according to the second embodiment. In FIG. 10, the same reference signs as in FIG. 2 represent the same or equivalent portions, and accordingly, detailed explanations thereof are omitted.

The object detecting apparatus 1 depicted in FIG. 9 includes the box generating unit 11, the box selecting unit 12, a weighting accepting unit 16, the overlap computing unit 17, the contribution computing unit 14 and the display processing unit 15.

The weighting accepting unit 16 is implemented by a weighting accepting circuit 26 depicted in FIG. 10, for example.

The weighting accepting unit 16 acquires weighting factors wf_{i,1}, . . . , wf_{i,J} of the first overlaps DS(1)_{i,1}, . . . , DS(1)_{i,J}.

The weighting accepting unit 16 outputs the weighting factors wf_{i,1}, . . . , wf_{i,J} to the overlap computing unit 17.

The overlap computing unit 17 is implemented by an overlap computation circuit 27 depicted in FIG. 10, for example.

The overlap computing unit 17 acquires one or more bounding boxes X_{i,j} of each object from the box generating unit 11.

The overlap computing unit 17 acquires a selected bounding box Xᵢ′ of each object from the box selecting unit 12.

The overlap computing unit 17 acquires a weighting factor wf_{i,j} from the weighting accepting unit 16.

The overlap computing unit 17 computes the first overlap DS(1)_{i,j} which is the overlap between each of bounding boxes X_{i,j} and the bounding box Xᵢ′.

The overlap computing unit 17 computes the second overlap DS(2)ᵢ by multiplying the first overlap DS(1)_{i,j} by the weighting factor wf_{i,j}, and adding together J first overlaps DS(1)_{i,j}×wf_{i,j} after the weighting factor multiplication.

The overlap computing unit 17 outputs, to the contribution computing unit 14, the second overlap DS(2)ᵢ of each object as the overlap DSᵢ of the object.

It is assumed in FIG. 9 that each of the box generating unit 11, the box selecting unit 12, the weighting accepting unit 16, the overlap computing unit 17, the contribution computing unit 14 and the display processing unit 15 which are constituent elements of the object detecting apparatus 1 is implemented by dedicated hardware like the one depicted in FIG. 10. That is, it is assumed that the object detecting apparatus 1 is implemented by the box generating circuit 21, the box selecting circuit 22, the weighting accepting circuit 26, the overlap computation circuit 27, the contribution computation circuit 24 and the display processing circuit 25.

Each of the box generating circuit 21, the box selecting circuit 22, the weighting accepting circuit 26, the overlap computation circuit 27, the contribution computation circuit 24 and the display processing circuit 25 is a single circuit, a composite circuit, a programmed processor, a parallel-programmed processor, an ASIC or an FPGA or a combination of these, for example.

The constituent elements of the object detecting apparatus 1 are not limited to those implemented by dedicated hardware, but the object detecting apparatus 1 may be implemented by software, firmware or a combination of software and firmware.

In a case where the object detecting apparatus 1 is implemented by software, firmware or the like, a program for causing the computer to execute each process procedure performed in the box generating unit 11, the box selecting unit 12, the weighting accepting unit 16, the overlap computing unit 17, the contribution computing unit 14 and the display processing unit 15 is stored in the memory 31 depicted in FIG. 3. Then, the processor 32 depicted in FIG. 3 executes the programs stored in the memory 31.

In addition, FIG. 10 depicts an example in which each of the constituent elements of the object detecting apparatus 1 is implemented by dedicated hardware, and FIG. 3 depicts an example in which the object detecting apparatus 1 is implemented by software, firmware or the like. However, this is merely an example, and some constituent elements of the object detecting apparatus 1 may be implemented by dedicated hardware, and the remaining constituent elements may be implemented by software, firmware or the like.

Next, operation of the object detecting apparatus 1 depicted in FIG. 9 is explained. Except for the weighting accepting unit 16 and the overlap computing unit 17, the operation is similar to the operation of the object detecting apparatus 1 depicted in FIG. 1. Because of this, here, operation of the weighting accepting unit 16 and the overlap computing unit 17 is mainly explained.

For example, a user operates a man-machine interface which is not depicted, and sets the weighting factors wf_{i,1}, . . . , wf_{i,J} of the first overlaps DS(1)_{i,1}, . . . , DS(1)_{i,J}.

The man-machine interface which is not depicted outputs the weighting factors wf_{i,1}, . . . , wf_{i,J} to the weighting accepting unit 16.

In the object detecting apparatus 1 depicted in FIG. 9, the man-machine interface which is not depicted outputs the weighting factors wf_{i,1}, . . . , wf_{i,J} to the weighting accepting unit 16. However, this is merely an example, and an external apparatus of the object detecting apparatus 1 may transmit the weighting factors wf_{i,1}, . . . , wf_{i,J} to the weighting accepting unit 16 via a communication device which is not depicted.

The weighting accepting unit 16 acquires the weighting factors wf_{i,1}, . . . , wf_{i,J} of the first overlaps DS(1)_{i,1}, . . . , DS(1)_{i,J} from the man-machine interface which is not depicted.

The weighting accepting unit 16 outputs the weighting factors wf_{i,1}, . . . , wf_{i,J} to the overlap computing unit 17.

The overlap computing unit 17 acquires one or more bounding boxes X_{i,j} of each object from the box generating unit 11.

The overlap computing unit 17 acquires a selected bounding box Xᵢ′ of each object from the box selecting unit 12.

The overlap computing unit 17 acquires the weighting factor wf_{i,j} from the weighting accepting unit 16.

Similarly to the overlap computing unit 13 depicted in FIG. 1, the overlap computing unit 17 computes the first overlap DS(1)_{i,j} which is the overlap between each of bounding boxes X_{i,j} and the bounding box Xᵢ′.

As depicted in the following Formula (3), the overlap computing unit 17 computes the second overlap DS(2)ᵢ by multiplying the first overlap DS(1)_{i,j} by the weighting factor wf_{i,j}, and adding together J first overlaps DS(1)_{i,j}×wf_{i,j} after the weighting factor multiplication.

$${DS ( 2 )}_{i} = {DS ( 1 )}_{i , 1} \times {wf}_{i , 1} + … + {DS ( 1 )}_{i , J} \times {wf}_{i , J} \qquad ( 3 )$$

The overlap computing unit 17 outputs, to the contribution computing unit 14, the second overlap DS(2)ᵢ of each object as the overlap DSᵢ of the object.

In the second embodiment mentioned above, the object detecting apparatus 1 is configured such that the overlap computing unit 17 computes the second overlap by performing weighted-addition of the first overlaps of all of the filters. Accordingly, the object detecting apparatus 1 can present the contributions of pixels contributing to detection of an object in a plurality of pixels included in the input image, and additionally can present the contributions of the pixels in such a manner that the contributions reflect weights on particular filters in one or more filters used by the OD-CNN.

### Third Embodiment

An object detecting apparatus 1 in which a plurality of sets of the box generating unit 11 and the box selecting unit 12 are cascaded is explained in a third embodiment.

That is, in the third embodiment, the object detecting apparatus 1 in which a plurality of sets of the OD-CNN and NMS are cascaded is explained.

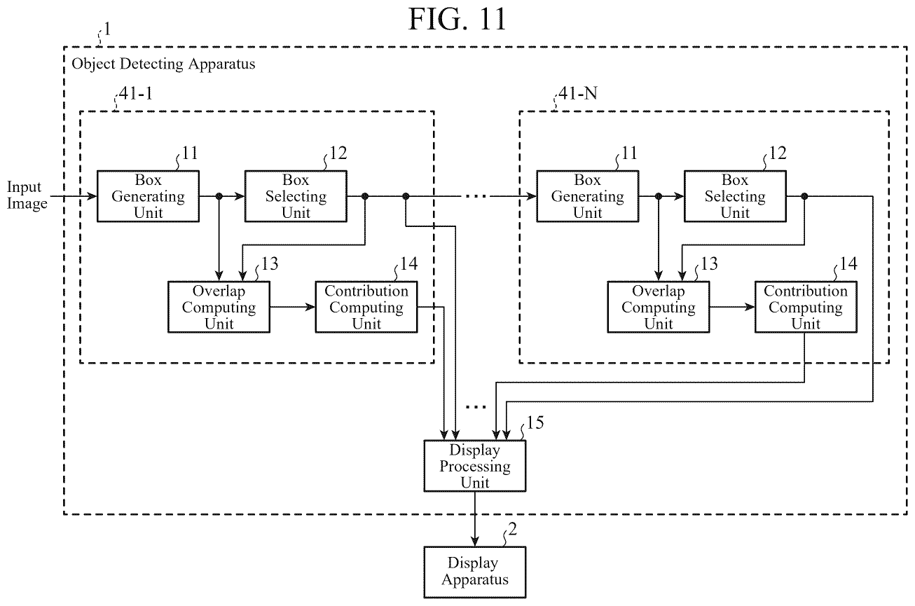

FIG. 11 is a configuration diagram depicting the object detecting apparatus 1 according to the third embodiment. In FIG. 11, the same reference signs as in FIG. 1 and FIG. 9 represent the same or equivalent portions, and accordingly, detailed explanations thereof are omitted.

The object detecting apparatus 1 depicted in FIG. 11 has N sets of the box generating unit 11 and the box selecting unit 12 and are cascaded with each other. N is an integer which is equal to or greater than two.

A set 41n (n=1, . . . , N) includes the box generating unit 11 and the box selecting unit 12, and additionally includes the overlap computing unit 13 and the contribution computing unit 14.

The set 41-1 is a set at the first stage, and the box generating unit 11 of the set 41-1 is provided with an input image. The box selecting unit 12 of the set 41-1 outputs a selected bounding box to each of the box generating unit 11 and the display processing unit 15 of a set at the second stage.

The contribution computing unit 14 of the set 41-1 outputs the computed contributions of pixels to the display processing unit 15.

The box generating unit 11 of a set 41-n (n=2, . . . , N) acquires a bounding box selected by the box selecting unit 12 of a set 41-(n−1), and outputs the bounding box to the box selecting unit 12 of the same set.

The box selecting unit 12 of the set 41-n (n=2, . . . , N) outputs a selected bounding box to the overlap computing unit 13 of the same set, and each of the box generating unit 11 and the display processing unit 15 of a set 41-(n+1). If the set 41-n is a set 41-N at the last stage, the box selecting unit 12 outputs a selected bounding box to each of the overlap computing unit 13 and the display processing unit 15 of the same set.

The contribution computing unit 14 of the set 41-n (n=2, . . . , N) outputs the computed contributions of pixels to the display processing unit 15.

In the object detecting apparatus 1 depicted in FIG. 11, the set 41-n (n=1, . . . , N) includes the box generating unit 11, the box selecting unit 12, the overlap computing unit 13 and the contribution computing unit 14 included in the object detecting apparatus 1 depicted in FIG. 1. However, this is merely an example, and the set 41-n (n=1, . . . , N) may include the box generating unit 11, the box selecting unit 12, the weighting accepting unit 16, the overlap computing unit 17 and the contribution computing unit 14 included in the object detecting apparatus 1 depicted in FIG. 9.

Next, operation of the object detecting apparatus 1 depicted in FIG. 11 is explained.

Operation of the box generating unit 11, the box selecting unit 12, the overlap computing unit 13 and the contribution computing unit 14 itself is similar to the operation of the object detecting apparatus 1 depicted in FIG. 1.

The overlap computing unit 13 of the set 41-n (n=1, . . . , N) computes the overlap between each of bounding boxes generated by the box generating unit 11 of the set 41-n and the bounding box selected by the box selecting unit 12 of the set 41-n.

The contribution computing unit 14 of the set 41-1 computes the contributions of pixels contributing to detection of an object in a plurality of pixels included in the input image on the basis of the overlap computed by the overlap computing unit 13 of the set 41-1.

The contribution computing unit 14 of the set 41-1 outputs a Grad-CAM image representing the contributions of the pixels to the display processing unit 15.

The contribution computing unit 14 of the set 41-n (n=2, . . . , N) computes the contributions of pixels contributing to detection of an object in a plurality of pixels included in a bounding box selected by the box selecting unit 12 of the set 41-(n−1) on the basis of the overlap computed by the overlap computing unit 13 of the set 41-n.

The contribution computing unit 14 of the set 41-n outputs a Grad-CAM image representing the contributions of the pixels to the display processing unit 15.

The display processing unit 15 acquires the Grad-CAM image from the contribution computing unit 14 of the set 41-n (n=1, . . . , N), and causes the Grad-CAM image to be displayed on the display of the display apparatus 2.

The plurality of the sets 41-n (n=1, . . . , N) of the box generating unit 11 and the box selecting unit 12 are cascaded in the third embodiment mentioned above. The object detecting apparatus 1 is configured such that each cascaded set 41-n includes the overlap computing unit 13 and the contribution computing unit 14. Accordingly, the object detecting apparatus 1 can present the contributions of pixels in each set even if a plurality of sets of the OD-CNN and NMS are cascaded.

Note that the present disclosure incorporates unrestricted combinations of embodiments, modifications of any constituent elements in embodiments and omission of any constituent elements in embodiments.

### INDUSTRIAL APPLICABILITY

The present disclosure is suitable for an object detecting apparatus and an object detection method.

### REFERENCE SIGNS LIST

1: object detecting apparatus, 2: display apparatus, 11: box generating unit, 12: box selecting unit, 13: overlap computing unit, 14: contribution computing unit, 15: display processing unit, 16: weighting accepting unit, 17: overlap computing unit, 21: box generating circuit, 22: box selecting circuit, 23: overlap computation circuit, 24: contribution computation circuit, 25: display processing circuit, 26: weighting accepting circuit, 27: overlap computation circuit, 31: memory, 32: processor, 41-1 to 41-N: set

1. An object detecting apparatus comprising:
processing circuitry configured to
detect an object in an input image and generate one or more bounding boxes enclosing the object;
select, if a plurality of mutually overlapping bounding boxes is generated, one bounding box from the plurality of mutually overlapping bounding boxes on a basis of a reliability of each of bounding boxes;
calculate an overlap between each of bounding boxes having been generated and the bounding box having been selected; and
calculate a contribution of a pixel contributing to the detection of the object in a plurality of pixels included in the input image on a basis of the calculated overlap.

2. The object detecting apparatus according to claim 1, wherein
the processing circuitry is further configured to detect the object in the input image by using a convolutional neural network which is an object detection algorithm, and
when the input image is provided, the convolutional neural network generates a bounding box enclosing the object in the input image by using each of one or more filters.

3. The object detecting apparatus according to claim 2, wherein
the processing circuitry is further configured to calculate each first overlap which is an overlap between each of bounding boxes generated by the convolutional neural network and corresponding to the number of filters and the selected bounding box, and calculate a second overlap which is a total of the first overlaps corresponding to the number of filters, and
the processing circuitry is further configured to calculate the contribution of the pixel contributing to the detection of the object in a plurality of pixels included in the input image on a basis of the calculated second overlap.

4. The object detecting apparatus according to claim 3,
wherein the processing circuitry is further configured to calculate the second overlap by weighted-addition of the first overlaps of all the filters.

5. The object detecting apparatus according to claim 1,
wherein the processing circuitry is further configured to cause an image representing the calculated contribution to be displayed.

6. An object detection method comprising:
detecting an object in an input image, and generating one or more bounding boxes enclosing the object;
selecting, if a plurality of mutually overlapping bounding boxes is generated, one bounding box from a plurality of mutually overlapping bounding boxes on a basis of a reliability of each of bounding boxes;
calculating an overlap between each of bounding boxes having been generated and the bounding box having been selected; and
calculating a contribution of a pixel contributing to the detection of the object in a plurality of pixels included in the input image on a basis of the calculated overlap.
